(19) United States
(12) Patent Application Publication
(10) Pub. No.: US 2025/0103854 A1
(43) Pub. Date: Mar. 27, 2025

(54) PREDICTIVE MAINTENANCE FOR DISTRIBUTED SYSTEMS

(71) Applicant: HEWLETT PACKARD ENTERPRISE DEVELOPMENT LP, Spring, TX (US)

(72) Inventors: FERDINAND KOENIG, Boblingen (DE); Karlo Kraljic, Dornach-Aschheim (DE); Christian Car, Boblingen (DE)

(21) Appl. No.: 18/476,161

(22) Filed: Sep. 27, 2023

(51) Int. Cl. G06N 3/0442; G06F 11/30; G06F 11/34; G06N 3/0455; G06N 3/088

(52) U.S. Cl. CPC G06N 3/0442; G06F 11/3006; G06F 11/3409; G06N 3/0455; G06N 3/088

(57) ABSTRACT

Predictive maintenance can be achieved by fetching log data from a monitoring application monitoring one or more hosts of a data center site. Based on the log data, a clique comprising a subset of the one or more hosts exhibiting sufficiently similar behavior is created. The log data may also be used to train a machine learning model configured to predict a need for predictive maintenance/existence of a predictive maintenance state for any of the subset of the one or more hosts of the clique. The machine learning model is trained with the log data, and the machine learning model is operationalized to predict the existence of anomalous data in further log data collected from the monitoring application. The existence of anomalous data reflects a need for predictive maintenance.

### BACKGROUND

The behavior of a computing system or a computing environment can vary over time and can be assessed based on various metrics that characterize aspects of that behavior. The behavior of a computing system/environment can involve various devices, applications, or events within or of a computing system/computing environment. In some cases, a computing system, such as a data center (an example of a distributed system), may exhibit periodic changes in its behavior that form part of an expected pattern of behavior. For instance, a system may undergo periodic backups during which various operational metrics may change due to activity associated with the backups. As an example, a sharp increase in read activity may be observed during the backups. In other cases, devices may degrade, for example, leading to less-than-optimal or less-than-desired system performance, making maintenance a factor to consider when trying to increase system reliability or cut down operating/maintenance costs, as well as system downtime.

### BRIEF DESCRIPTION OF THE DRAWINGS

The present disclosure, in accordance with one or more various examples, is described in detail with reference to the following figures. The figures are provided for purposes of illustration only and merely depict typical examples.

FIG. 1 illustrates an example of a data center site in which examples of the disclosed technology may be implemented.

FIG. 2 is a schematic representation of a predictive maintenance system in accordance with one example of the disclosed technology.

FIG. 3 is an example computing component that may be used to implement data collection and measurand iteration in accordance with one example of the disclosed technology.

FIG. 4 is an example computing component that may be used to implement host group creation in accordance with one example of the disclosed technology.

FIG. 5 is an example computing component that may be used to implement data preparation in accordance with one example of the disclosed technology.

FIG. 6 is an example matrix representing host measurand values at certain times.

FIG. 7A is an example graphical domain representation of data center hosts and determined correlations thereof.

FIG. 7B is an example matrix representation of FIG. 7A indicating determined correlations.

FIG. 8A is an example graphical domain representation of data center hosts indicating determined correlations suggesting similar host behavior warranting a host group.

FIG. 8B is an example representation of FIG. 8A indicating per-host-group features matrix that has been imputed and min-max scaled.

FIG. 9 is an example time-host matrix representative of a host's state at a given point in time.

FIG. 10 is an example computing system that may be used to implement various features of predictive maintenance for distributed systems in accordance with examples of the disclosed technology.

The figures are not exhaustive and do not limit the present disclosure to the precise form disclosed.

### DETAILED DESCRIPTION

As noted above, maintenance is a consideration when attempting to increase computing system reliability and cut down on operating costs. Indeed, and for example, a common objective amongst data center operators is to reduce the effort and cost (and avoid any penalties) associated with breaching data center service-level agreements with its customers or tenants. Conventional predictive maintenance mechanisms tend to be premised on the degradation of devices, parts, etc. or other like indicators. As also noted above, computing systems in which predictive maintenance may be implemented can be large-scale, distributed data centers. Due to the scale and distributed nature of such data centers, the number of devices, applications, and events making up or provided by these data centers can be very large and diverse, making it difficult, if not impossible, (or at the very least, impractical) for human actors to monitor data center system “stacks,” let alone analyze huge amounts of data center logs to investigate and identify the root causes of issues. Even if human actors attempted to effectuate predictive maintenance, the exercise would be error-prone given the amount of data to review and analyze.

Accordingly, the disclosed technology is directed to solutions rooted in computer technology to overcome the technical problem(s) arising in the realm of computer networks/computing systems, namely the above-described issues with large scale/distributed system predictive maintenance. In particular, examples of the disclosed technology can perform condition-based monitoring to enable predictive maintenance using data science, where “normal” system behavior can be learned, and any deviant behavior, i.e., anomalies, can be detected. Upon detecting such anomalies, the anomalies can be examined and remedied before any negative symptoms arise. That is, data from agents monitoring various operating systems, devices (switches, processors, etc.), events, and so on may be collected and aggregated. Certain operations may be performed to normalize or otherwise prepare/process the received data for use in a following aspect of the disclosed technology, i.e., examination of the data for applying and developing a machine learning (ML) model for predicting the need for maintenance. The ML model can then be evaluated and deployed.

“Anomalies” may refer to data items that deviate significantly or by some given amount, such as a threshold amount, from the majority of the other data items. These anomalies or outliers can occur because of noise or unexpected data points that influence model prediction behavior. In this context, such anomalies may suggest some maintenance of a host device, application, etc. may be warranted.

It should be noted that the development and deployment or operationalization of ML models in accordance with examples of the disclosed technology occurs on a per-host-group or clique basis. That is, in some examples, the aforementioned examination of data can involve determining whether two or more hosts of a particular (single) data center site or system behave similarly. Based on one or more thresholds, a determination can be made regarding whether such similarities can be deemed to mean such hosts are highly or otherwise, sufficiently correlated, such that they can be combined for ML model development purposes. If two or more hosts are correlated, a single ML model can be developed for those two or more hosts, i.e., a per-host-group model. In this way, the specificity of ML models can be balanced with high abstraction and low numbers of models being used/implemented amongst the multiple hosts of a data center site. That is, less ML models are used in accordance with examples of the disclosed technology when compared to a one-model-per-host approach, but the ML models developed in accordance with examples of the disclosed technology are more specific (better-trained and predictively better) than an approach where only one ML model is used per data center site. It should be understood that even if only one ML model is developed/used for a single data center site, development of that one ML model in accordance with the disclosed technology (taking into account correlations) will result in an ML model that is specific to, e.g., all the hosts of the data center site, because all the hosts exhibit similar behavior. Moreover, when properties or features, also referred to as measurands, are added or removed to/from a host(s), only the host-group to which the modified host(s) belong, along with the host-groups, are retrained. Hosts in this context can refer to e.g., servers or computing systems housed in a data center for delivering resources, such as software applications, databases, files, etc. to users that may be remote from the data center.

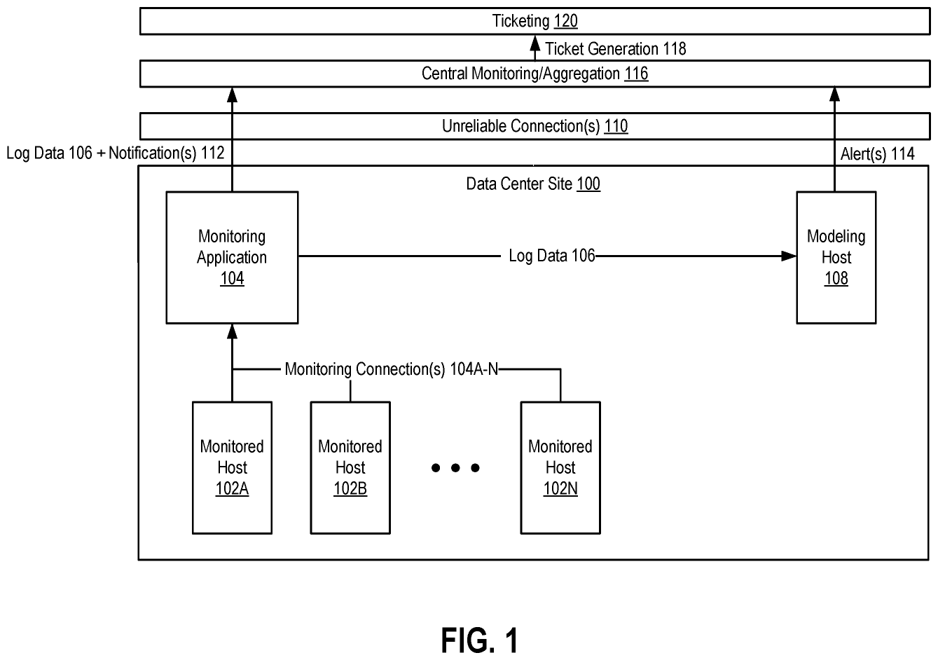

FIG. 1 illustrates an example data center site or system 100. Data center site or system 100 can be a physical or logical data center site. As can be appreciated from FIG. 1, a monitoring application 104 (which monitors hosts 102A, 102B, . . . 102N via monitoring connections 104A-N, respectively) can generate log data 106 from the monitored hosts 102A-102N. Such log data 106 can be shared with a modeling host 108 as well as a central monitoring and aggregation application 116. It should be noted that typically, data centers (made up of multiple data center sites) include a centralized management entity or function, e.g., an “operations center,” that provides operational visibility across various data center sites of a data center. As will be described in greater detail below, in the event a connection 110 to central monitoring and aggregation application 116 is lost or otherwise unavailable/inaccessible (an unreliable connection), the inclusion of modeling host 108 allows log data to still be obtained/processed for data center sites. Accordingly, as illustrated in FIG. 1, modeling host 108 may have a connection, such as a dedicated communications connection, with monitoring application 104. Central monitoring and aggregation application 116 may forward alerts 114 (further discussed below), generate tickets, as well as provide contextual information regarding monitored data, evaluate service-level agreements to determine fulfillment thereof, and so on. It should be understood that central monitoring/aggregation application 116 can be implemented in a central data center management system, as part of a “main” data center site, e.g., at a headquarters of an enterprise. Monitoring application 104 may also generate and transmit notifications to central monitoring and aggregation application 116. In turn, central monitoring and aggregation application 116 can generate tickets 118 that can be sent to ticketing component 120. In this way, any issues can be identified and addressed.

It should be noted that connections from individual data center sites, such as data center site 100, can be unreliable. This is represented in FIG. 1 by unreliable connection(s) 110. Thus, the aforementioned predictive maintenance functionality may be implemented in each data center site, in this example, modeling host 108, described in greater detail below. In other words, even if a data center site, such as data center site 100 becomes cut off from central monitoring and aggregation application 116, it may nevertheless still effectuate predictive maintenance for its own hosts in accordance with one or more examples of the disclosed technology.

Monitoring application 104 can be any one or more appropriate monitoring applications, one example of which is Nagios®, a monitoring tool that can run periodic checks on determined parameters of applications, network, and server resources or devices. For example, central monitoring and aggregation application 116 may fetch or retrieve log data 106 from monitoring application 104. In accordance with a ruleset(s) applicable to the data center site, monitoring application 104 may create notifications 112 that can be sent to central monitoring and aggregation application 116. Central monitoring and aggregation application 116 can write notifications 112 to a database (not shown) or similar repository.

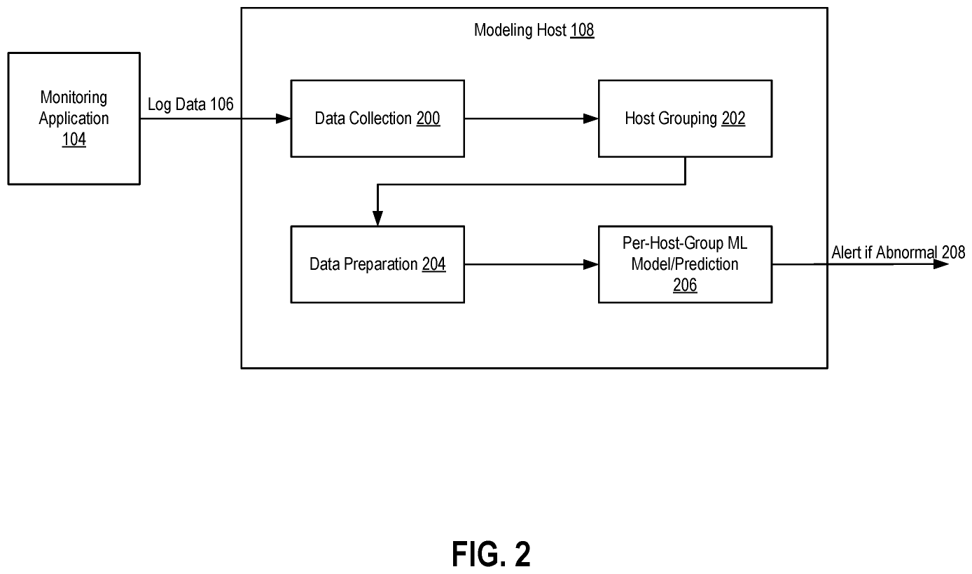

Modeling host 108 can refer to a host specific to data center site 100 for developing and implementing the ML model(s) for use in predicting maintenance at data center site 100. As illustrated in FIG. 2, modeling host 108 may comprise a plurality of components, including, for example, data collection component 200, host grouping component 202, data preparation component 204, and ML prediction component 206, i.e., an appropriate ML model. As noted above, log data 106 may be received or fetched from monitoring application 104. Thus, log data 106 from one or more of data centers 102A-N(FIG. 1A) can be input to data collection component 200. Log data 106 may be raw, time-series log data from monitoring application 104.

Continuing with the description of FIG. 2, hosts may then be grouped by host grouping component 202, where host groups can also be referred to cliques. As alluded to above, the grouping of hosts for the purpose of developing ML models allows for the creation of ML models specific to host groups or cliques exhibiting similar behavior. Again, the use of an ML model to predict maintenance across multiple hosts reduces the number of models that need to be implemented, and the ML model can be more easily adapted to changing properties/features of one or more of the multiple hosts.

Data preparation component 204 may process, e.g., normalize/scale/impute, the data and prepare the data to be fit and predicted by an appropriate ML model, once/when that ML model is operationalized at data center site 100. If the appropriate ML model implemented for predictive maintenance regarding some host group or clique, upon having the prepared data from data preparation component 204 applied thereto, detects the existence of abnormal data, i.e., data anomalies, an alert 208 (an example of alert(s) 114 of FIG. 1) can be generated by ML model/prediction component 206. The alert 208 can be sent to central monitoring and aggregation application 116, as explained above.

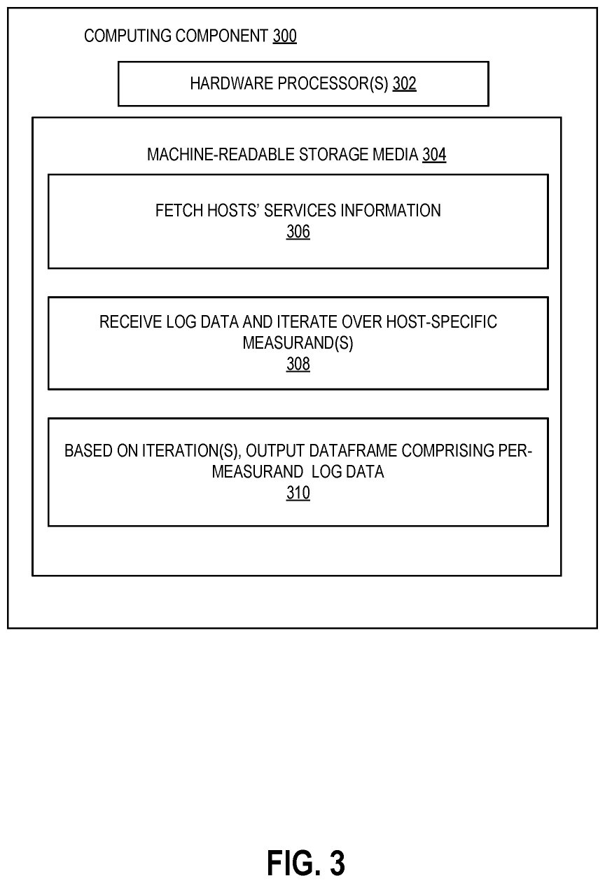

Data collection component 200, host grouping component 202, and data preparation component 204 will be described in greater detail in conjunction with FIGS. 3-5, respectively.

FIG. 3 is an example computing component that may be used to implement data collection in accordance with one example of the disclosed technology. Computing component 300 may be integrated in a host of a data center site, such as modeling host 108 of data center site 100 (FIG. 1A). The computing component 300 may be, for example, a server computer, a controller, or any other similar computing component capable of processing data. In the example implementation of FIG. 3, the computing component 300 includes a hardware processor 302 and machine-readable storage medium 304.

Hardware processor(s) 302 may be one or more central processing units (CPUs), semiconductor-based microprocessors, and/or other hardware devices suitable for retrieval and execution of instructions stored in machine-readable storage medium 304. Hardware processor(s) 302 may fetch, decode, and execute instructions, such as instructions 306-310, to control processes or operations for performing data collection, i.e., raw, time-series data collection from monitoring application 104. As an alternative to or in addition to retrieving and executing instructions, hardware processor(s) 302 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 304, may be any electronic, magnetic, optical, or other physical storage device that contains or stores executable instructions. Thus, machine-readable storage medium 304 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 304 may be a non-transitory storage medium, where the term “non-transitory” does not encompass transitory propagating signals. As described in detail below, machine-readable storage medium 304 may be encoded with executable instructions, for example, instructions 306-310.

Hardware processor 302 may execute instruction 306 to fetch hosts' services information. That is, a list of all logged services associated with relevant hosts of a data center site may be fetched by data collection component 200. Again, each service of a host may be associated with multiple measurands.

To the above, hardware processor 302 may execute instruction 308 to receive log data, and iterate over host-specific measurands. As discussed above, such log data may be raw, time-series data received by data collection component 200 from an instance of monitoring application 104 local to a physical or logical data center site. Again, measurands are properties or features/characteristics of hosts. Thus, the algorithm pursuant to which data collection component 200 operates, is designed to iterate over all measurands per host. In other words, data collection component 200 may use an algorithm to retrieve raw, time-series data corresponding to each property/feature of a host. In this way, log data relevant to each host measurand can be determined. After receiving the list of data center site hosts, e.g., hosts 102a-102n, along with the hosts' respective measurands from the log data 106 received from monitoring application 104, data collection component 200 may iterate over the host-specific measurands. That is, data collection component 200 requests time-series data associated with or applicable to each measurand over a given period of time. The response to a request from data collection component 200 can include data for one service, and may hold multiple measurands, i.e., multiple time series.

Hardware processor(s) 302 may then execute instruction 310 to output data comprising per-measurand log data based on the iteration(s) over the host-specific measurands. In some examples, the data that is output is a DataFrame in a long format having the following information elements: monitoring application, e.g., Nagios, host identifier, service, timestamp ts, measurand, and a corresponding value. The aforementioned DataFrame can refer to a Pandas DataFrame data structure, a 2-dimensional array or row-column table. For example, iterating over each measurand, instruction 310 (the algorithm) may output a file comprising log data corresponding to each host measurand for every given time period, say, every 300 seconds, for example. It should be understood that the DataFrame data structure may be derived from an HTTPS JSON response, e.g., to a request for the time-series data applicable to each measurand, where for each time-series data request, metadata is provided that indicates a time of the data samples comprising the time-series data. Such metadata can be added to the DataFrame and saved.

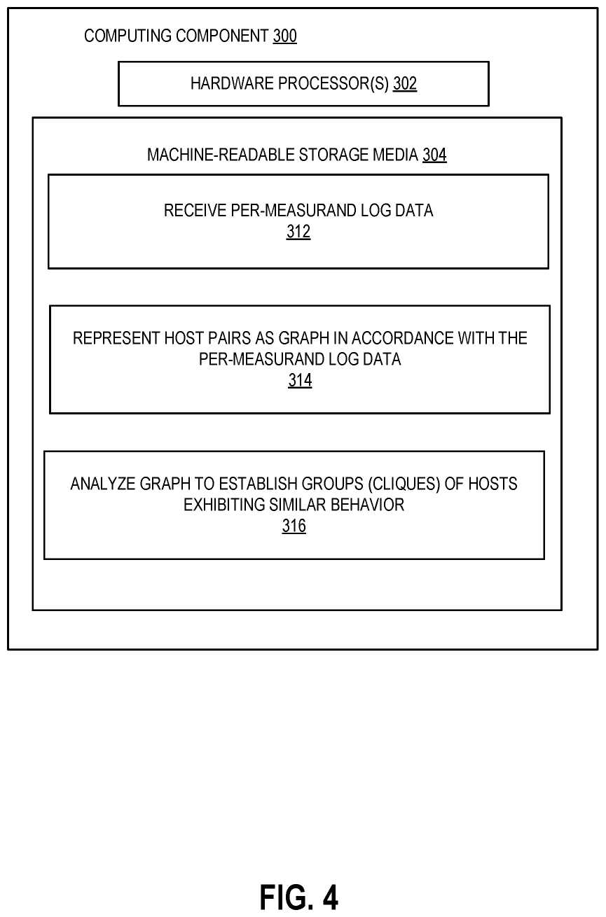

Again, to balance the specificity of the models (per-host-group/clique) while keeping the number of models low and their abstraction high, hosts with similar behavior are grouped into cliques by host grouping component 202. Referring now to FIG. 4, FIG. 4 illustrates example computing component 300, comprising hardware processors 302 and machine-readable storage media 304 that may also be used to implement host grouping in accordance with one example of the disclosed technology. Accordingly, machine-readable storage medium 304 may be encoded with executable instructions, for example, instructions 312-316.

In other words, hardware processor(s) 302 may execute instruction 312 to receive per-measurand log data. As discussed above, the algorithm pursuant to which data collection component 200 operates, is designed to iterate over all measurands per host. In this way, log data relevant to each host measurand can be determined. For example, at a particular host of a data center site, Nagios® may be used as a monitoring application that monitors the behavior of the particular host. A requested service regarding that particular host may be a ping service (typically used to test and verify whether or not some Internet Protocol (IP) address exists), in this case, to test whether or not the host is operational. Accordingly, applicable measurands may be, e.g., round trip average (“rta”) and round trip maximum (“rtmax”), as well as memory availability.

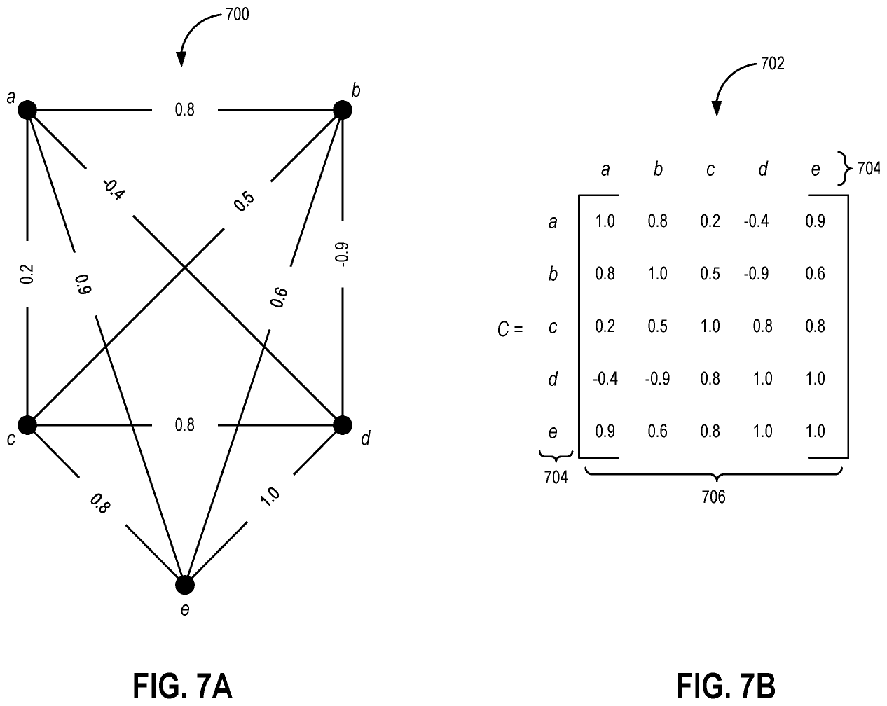

Hardware processor(s) 302 may execute instruction 314 to represent host pairs as a graph in accordance with the per-measurand log data. Host pairs x, y within a data center site can be represented as a graph G (see FIG. 7A). In such a graph G, vertices or “nodes” can be representative of hosts of a data center site (in this context). The edges of graph G that connect the vertices can represent some relationship between the vertices, in this context, determined correlations between host pairs x, y. Recall that the per-measurand log data includes information regarding, per host, that host's provided service(s), measurand(s), and values representative of the behavior/performance of that host corresponding to such services (and iterated over the measurands). Graph G reflects this per-measurand log data between host pairs. Typically, because examples of the disclosed technology are directed to preventive maintenance, all hosts of a data center site are monitored. However, if for some reason, one or more hosts of a data center site need to be considered, those hosts may be excluded for ML model development purposes.

As an example, the features (measurands) over time of a pair of hosts (in this example, host x and host y) may have a correlation represented by the following function, ρ_{xy} (−1≤ρ≤1). If the correlation ρ between hosts x and y exceeds a threshold Y, then x, y are deemed to be highly similar or sufficiently similar to warrant inclusion of the host pair in a host group or clique. Threshold y can be set to a desired value, e.g., 0.7, 0.8, etc. (other threshold values may be used to create a desired manner of grouping hosts).

Hardware processor(s) 302 may execute instruction 316 to analyze the host pairs graph to establish groups (cliques) of hosts that share similar behavior. That is, analyzing graph G may involve identifying or determining “complete subgraphs” of G, where such complete subgraphs are groups of hosts, where the hosts of a complete subgraph mutually share a high similarity. This can be referred to as a “clique” problem, the goal of which is to find complete subgraphs or cliques (i.e., subsets of vertices, adjacent to one another), which in this context, again, results in groups of hosts. However, if a new host to a data center site cannot be assigned to a clique, log data from that new host can be collected over some amount of time to maximize available training data while minimizing the initial time without a prediction model.

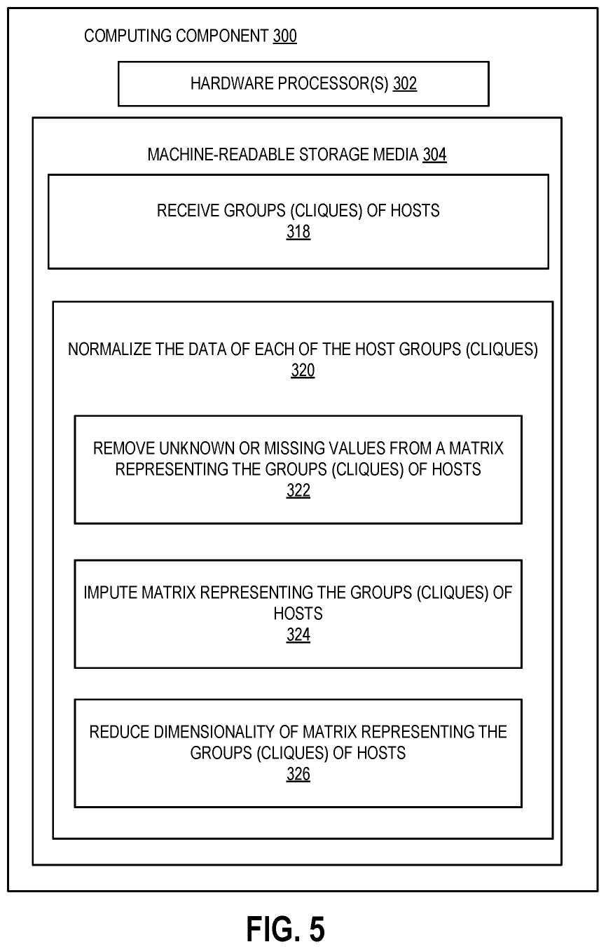

As alluded to above, data preparation component 204 may process the data and prepare the data to be fit and predicted by an appropriate ML model. Referring now to FIG. 5, FIG. 5 illustrates example computing component 300, comprising hardware processors 302 and machine-readable storage media 304 that may also be used to implement data preparation in accordance with one example of the disclosed technology. Accordingly, machine-readable storage medium 304 may be encoded with executable instructions, for example, instructions 318-326.

Accordingly, hardware processor(s) 302 may execute instruction 318 to receive groups (cliques) of hosts. That is, data preparation component 204 may receive information identifying groups/cliques and the host(s) that correspond to those groups/cliques.

Hardware processor 302 may execute instruction 320 to normalize the data of each of the host groups. As discussed above, the data received from a monitoring application can be a long format DataFrame. This long format DataFrame may be transformed into “host matrix.” As noted above, some hosts may not have valid values for a particular measurand, i.e., not-a-number (NaN) values/non-values. Accordingly, hardware processor(s) 302 may execute instruction 322 to remove such values from the host matrix. Hardware processor(s) 302 may execute instruction 324 to impute the matrix. Imputation can refer to estimate missing values based on data distribution assumptions. Here, the host matrix can be imputed by replacing any/all missing values, i.e., NaN values, with a zero (0) value. Moreover, the host matrix is min-max scaled. That is, min-max or feature scaling (also referred to as min-max normalization) can be used to perform a linear transformation on the original data of the host matrix. The result is that data of the host matrix is normalized to be within the range (0,1), while still preserving relationships between the original data. As discussed above, the large scale and distributed nature of data centers can result in large data sets.

Returning to FIG. 2, per-host-group/per-clique ML model or prediction component 206 refers to the ML model used to determine the existence of anomalies in received log data 106 from monitoring application 104. A health metric may define a threshold regarding when an observed host behavior amounts to an anomaly. In addition, prioritizing anomalies becomes possible. As described before, examples of the disclosed technology, when implemented, results in the creation and operationalization of a single ML model per clique or host-group, leading to the preservation of adaptability. That is, when host features or measurands are added or removed, only those cliques and their respective ML models are retrained, i.e., enabling modularity. Further still, systems confirmed or designed in accordance with examples of the disclosed technology are independent of/are not impacted by potentially unreliable connections to the data center. That is, with the inclusion of a model host, e.g., modeling host 108 at each data center site, the ML models of each data center site (corresponding to the applicable cliques) can be changed as desired independent of any larger data center network (or other data center sites) to which the data center sites may belong.

In some examples of the disclosed technology, autoencoders may be used to determine whether received log data contains anomalous data. An autoencoder refers to an unsupervised or self-supervised artificial neural network that learns how to efficiently compress and encode data into a latent space and reconstruct the data back from the reduced encoded representation. In other words, an autoencoder is able to learn a compressed representation of input data, in particular and in this context, dependencies between time steps in time-series/sequence data. Use of an autoencoder, such as a Long Short-Term Memory (LSTM) autoencoder, is appropriate because an encoded representation learned by the autoencoder is specific to the received log data, i.e., training dataset. This enables an LSTM autoencoder to fit data based on an assumption that the majority of the received log data is normal as opposed to anomalous. More broadly explained, all items of the feature vectors (the vectors that represent a state of a host) are min-max-scaled. Thus, per-clique ML model or prediction component 206 is designed to be good, i.e., accurate, at reconstructing normal/non-anomalous data, but not as good for reconstructing abnormal data. In this way, the reconstruction error (described in greater detail below) for anomalous data is higher than that for normal, data. A threshold for the reconstruction error can be set in order to label feature/measurand vectors as an anomaly. It should be understood that such labeling can occur during training of the per-clique ML model or prediction component 206 so that upon receipt of the same/similar log data during operationalization, per-clique ML model or prediction component 206 can predict the existence of an anomaly.

Typically, an LSTM autoencoder is made up of layers, which in turn, comprise LSTM cells. The term unit can be used to refer to a number of LSTM cells per layer. In one example of the disclosed technology, log data 106 can be batched to have sequences of five samples per batch to provide a learnable temporal context. The autoencoder may be symmetrical in accordance with one example of the disclosed technology, e.g., the weights of corresponding layers are set to be symmetrical, where the encoder may comprise two LSTM layers, a first having 128 LSTM cells or 128 respective units, and a second having 64 LSTM cells, i.e., 64 respective units that will act as an input for a subsequent layer. A corresponding decoder's first LSTM layer will have 64 LSTM cells or 64 units, while the decoder's second LSTM layer will have 128 LSTM cells or 128 units. To get a health score, the reconstruction error (Root Mean Squared Error (RMSE)) is subtracted from 1. If the health value is below a given/desired threshold, as one example, θ=0.7, an alert is raised.

Consider first, a training period, where there are some min/max values associated with each host feature/measurand in the training data. To min-max scale means to move/shift values such that the minimum value of a given feature is mapped to “0,” while the maximum value of a given feature is mapped to “1.” In between the 0 and 1 values, the scale is linear, e.g., if a value happens to be exactly between both (min and max), that value will be encoded as 0.5, and so on. Hence, the image of all items of the feature vectors is [0,1]. Therefore, the aforementioned RMSE (which compares an input vector with a reconstructed vector) is in [0,1] (0 being perfect reconstruction and 1 being completely off). In turn, the health score (1−RMSE) is also in between 0 and 1 (inclusive)). This allows a subject's health to be interpreted as 0% to 100% healthy. It should be noted, however, that in operation, the actual values (items of the vector) might exceed the maximum value or may be lower than the minimum value. Thus, the min-max-scaling may produce values that are higher than 1 or lower than 0. Therefore, the reconstruction error (RMSE) can be higher than 1 (in operation) and the health score can actually be lower than 0. This problem is not trivial to fix due to nonlinearity (of this metric and the LSTM-autoencoder as a concept). In practice, a cut-off is employed, where values lower than 0 can be cut off/ignored. In some examples of the disclosed technology, alerts may be generated when data reflects less than 0% health, possibly suggesting some severe/abnormal state, e.g., an indication that the status of the machine is even more a-normal than 0% health.

Further regarding training, when initially setting up modeling host 108, there are not yet any existing ML models or cliques. Initial data collection by monitoring application 104 occurs over some given time period, e.g., one week. Data collection component 200 fetches the (raw log) data from monitoring application 104. As described in accordance with examples of the disclosed technology herein, host-groups or cliques are determined/generated. That is, logged services information associated with the hosts of a data center site are fetched, e.g., a file(s) comprising tables reflecting hosts' services, or through the use of pipes to directly pipe data to a next component. The tables are merged to create a single “raw” table, from which a host matrix, H, can be created. Host matrix H can be used to create one or more cliques of hosts. As will be described below, all NaN hosts (hosts for which no data exists) are removed from host matrix H.

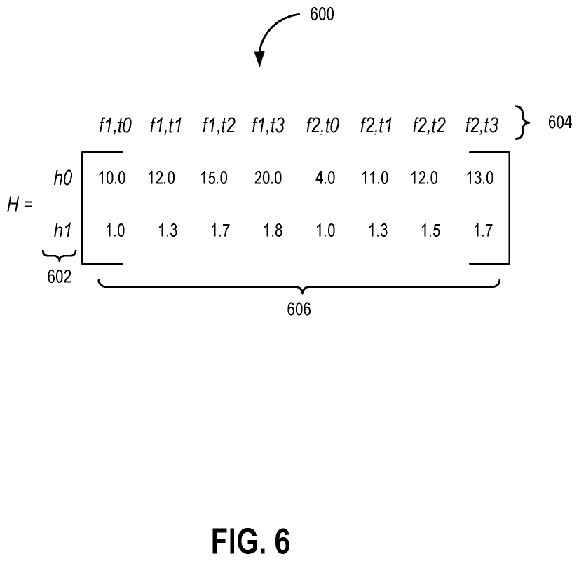

FIGS. 6-8 along with their corresponding descriptions present an example host-group/clique determination in accordance with one example of the disclosed technology.

Beginning with FIG. 6, a matrix representation 600 of two example hosts, h0 and h1 is shown (e.g., a host pair 602). Each of hosts h0 and h1 of host pair 602 have two associated measurands or features, f{1,2}. Matrix H reflects, for each host, h0 and h1, a value (collectively, the values 606) associated with their respective features (f{1, 2}) across/iterated over a period of time that includes three measuring points, t{0, 1, 2, 3}, e.g., sample points 604 (f1, t0; f1, t1; f1, t2; f1, t3; f2, t0; and so on. Recalling the above discussion, data collection component 200 receives raw log data, and outputs a long form DataFrame, which can be transformed into the H matrix 600 of FIG. 6.

Again, the output of data collection component 200 may include the following information: host identifier, timestamp t; measurand(s); corresponding value. As can be appreciated from FIG. 6, for feature f1, both hosts h0 and h1 of host pair 602 exhibit a trend or behavior of increasing values at subsequent time periods. For example, host h0's feature value for feature f1 at time to is 10.0, and increases to 12.0 at time t1, to 15.0 at time t2, and so on. Likewise, host h1's feature value for feature f1 at time to is 1.0, and also increases to 1.3 at time t1, to 1.7 at time t2, and so on.

At this point, a pairwise correlation operation can be performed between the two hosts, h0 and h1 of host pair 602. In one example, a correlation coefficient, ρ, can be determined as desired. Correlation coefficient, ρ, can be a numerical value within the range −1 to 1, and can be used to reflect the strength (and direction) of a relationship between two variables, in this case, between hosts h0 and h1 of host pair 602. In other words, correlation coefficient ρ is the ratio between the co-variance of two variables, and the product of their standard deviations, i.e., a normalized covariance measurement that always has a value between −1 and 1.

Accordingly, and referring now to FIG. 7A, a graphical representation of a plurality of hosts a-e (correlation graph 700) is illustrated. Hosts a-e 704 may be hosts of a single data center site, and the similarity between the behaviors of hosts a-e 704, i.e., their correlation, can be determined. As illustrated in FIG. 7A, each of hosts a-e 704 is represented as a vertex or node, with the edges therebetween reflecting a host-pair's correlation (collectively correlation coefficients 706). For example, hosts a and b have a correlation coefficient of 0.8, while the correlation between hosts a and c is 0.2, and so on. As will be described, this pairwise correlation determination between host pairs can be repeated for the host pairs of a data center site.

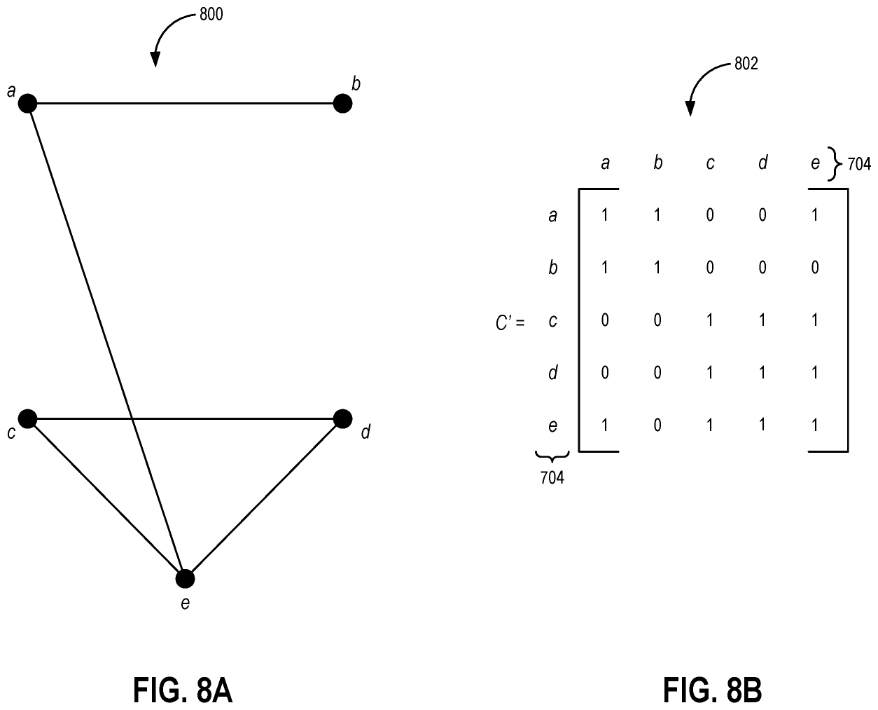

FIG. 7B illustrates a matrix representation 702 of the correlation graph 700 of FIG. 7A. The matrix representation 702 can be generated by transposing the above-discussed H matrix 600 for applicable host pairs, e.g., host pair 602. That is, the correlation graph 700 of FIG. 7A can be representative of hosts 704 associated with a particular data center site (e.g., data center site 100 of FIG. 1) and the hosts' relative correlations (correlation coefficients 706) between one another. It should be appreciated that because of the pairwise host “structure” of the correlation graph 700, the correlation matrix 702, C, which results from transposing the H matrix 600, is symmetric about the main diagonal of the C matrix 702 (where the values representative of a host relative to itself has a correlation coefficient of 1.0), in other words, a value of C in the correlation (also referred to as edge) graph 700 of FIG. 7A. It should be noted that in some scenarios, a host may not have an associated value, e.g., the values associated with a particular host and it's feature(s) are “Not a Number” (NaN). Any NaN values may be removed from an H matrix prior to transposing to the correlation matrix, C. The H matrix may be transposed, followed by pairwise correlation of columns of the resulting correlation matrix, C 702. A mask with a determined correlation threshold γ (discussed above) can be applied to change the correlation matrix C 702 to a derived matrix C′ (802 of FIG. 8B)), which comprises Boolean values that indicate whether a correlation between two hosts is high or not. In other words, correlation threshold γ acts as a filter, where derived matrix C′ 802, replaces the correlation coefficients 708 with either 1s or 0s depending on whether or not the correlation coefficient representing the relationship between two hosts meets or exceeds correlation threshold y.

FIG. 8A is an unweighted graphical representation 800 of the correlation graph 700 of FIG. 7A post-filtering using a correlation threshold y. That is, in this example, using correlation threshold y, only those edges that meet/exceed the correlation threshold Y (e.g., 0.7) are retained. Referring back to FIG. 7A, it can be appreciated that the remaining host-pair correlations of this example are host-pairs h{a,b}, h{a,e}, h{c,d}, h{c,e}, h{d,e} because each of these host-pairs have correlation coefficients of 0.8 or 1.0, which exceed the correlation threshold γ of 0.7. FIG. 8B reflects derived correlation matrix C′ 802, where missing values are replaced by 0, which is as-of-yet, unweighted, thereby reflecting the graph 800 of FIG. 8A in matrix form. A value of 1 can be thought of as representing the existence of an edge between two hosts, whereas a value of 0 can reflect the lack of existence of an edge between the hosts. As can be appreciated, those hosts whose edges correspond to either NaN values that have been removed or correlation coefficients that do not meet/exceed the given correlation threshold γ are reflected as zeros in derived correlation matrix C′ 802.

In the event that a new host is added to a data center site, an attempt can be made by the data center site's modeling host, e.g., host grouping component 202 of modeling host 108, to correlate the new host to one or more other, existing hosts of the data center site. That is, the new host may be considered when determining correlations between host-pairs of the data center site, as already described herein. If the new host has shared similarity to other hosts, the new host can be added to an existing host-group/clique, and the same ML model used to predict when a host resource may need maintenance/when the host resource may be in/experiencing a predictive maintenance state can be used to predict maintenance for the newly added host. If the newly added host does not have sufficient similarity/correlation to an existing host-group/clique, the data center site's modeling host can collect log data from the new host over some given period of time, e.g., one week, two weeks, etc. Based on such log data, a new clique can be created that includes the new host.

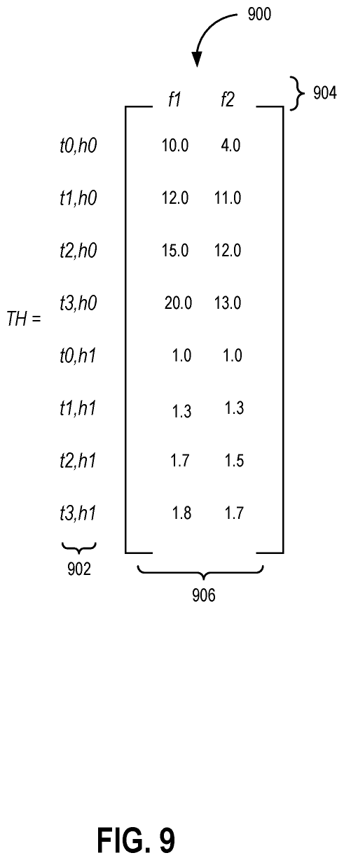

After clique determination, training the per-clique ML model comes next. Referring back to FIG. 6, and as described above, host matrix H represents a sample (the data of interest) per row, each row corresponding to single host. The data includes feature/measurand values of a given host at various points in time. That same data can be used to, now, train an ML model for a determined clique. Referring to FIG. 9, a time-host (TH) matrix is generated containing the same information as that of host matrix H. However, in this context, the data of interest or sample/row corresponds to the state of a host at a given time. Thus, as can be appreciated, FIG. 9 illustrates time-host matrix TH, where each row of the TH matrix corresponds to the state/value of a feature, in this case, features f1, f2, at various points in time. For example, matrix TH comprises eight rows, the first four of which correspond to f1 and f2 states of host h0, the second four of which correspond to f1 and f2 states of host h1. The relevant portion of matrix TH can be derived by removing the data for hosts that are not in the given clique. This relevant portion of TH for a clique, c, can be referred to as TH_{c}. NaN vectors are now removed from matrix TH_{c}. Then, matrix TH_{c} can be imputed and min-max scaled. Optionally, PCA can be performed. In this ML model training phase, host grouping component 202 is not utilized (given that cliques have already been determined). Rather, data preparation component 204 takes the same log data 106 provided by data collection component 200 and processes the log data 106 for use with ML model/prediction component 206. As described above, processing the log data 106 can involve, e.g., extracting for every clique, c, a feature matrix, TH_{c}, from the log data 106 by removing hosts that are not part of clique c, and removing any NaN vectors (i.e., those features that are not used by the clique's hosts). Furthermore, log data 106 may be imputed, i.e., any remaining NaN values are replaced by the value “0,” and min-max scaled, resulting in TH_{imp,scal}. The log data 106, in particular, TH_{imp,scal} can be considered to be ready for use by ML model/prediction component 206.

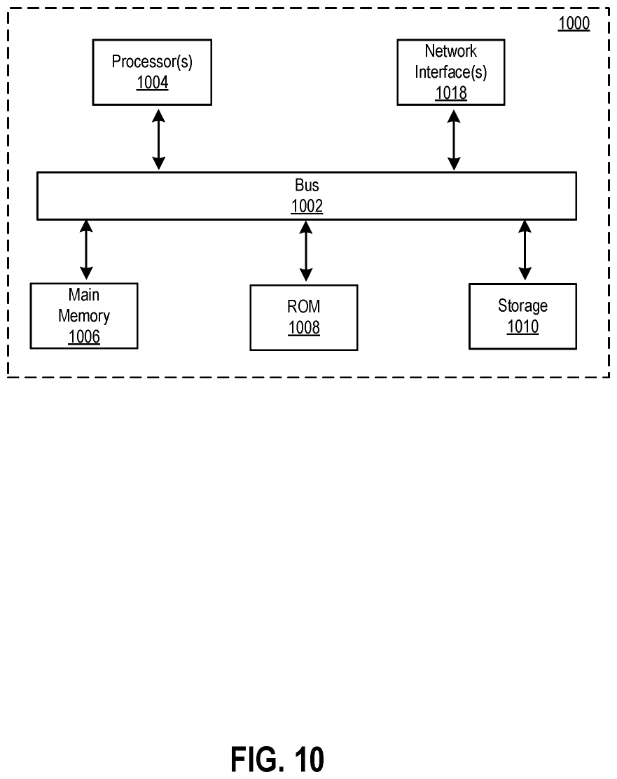

FIG. 10 depicts a block diagram of an example computer system 1000 in which various of the examples described herein may be implemented, including but not limited to hosts 102a-n, modeling host 108, data center site 100 (FIG. 1), data collection component 200, host grouping component 202, data preparation component 204, ML model/prediction component 206 (FIG. 2), or computing component 300 (FIGS. 3-5). The computer system 1000 includes a bus 1002 or other communication mechanism for communicating information, one or more hardware processors 1004 coupled with bus 1002 for processing information. Hardware processor(s) 1004 may be, for example, one or more general purpose microprocessors.

The computer system 1000 also includes a main memory 1006, such as a random access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions.

The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), is provided and coupled to bus 1002 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1000 may implement the techniques described herein using customized hard-wired logic, one or more ASICs or FPGAs, firmware and/or program logic which in combination with the computer system causes or programs computer system 1000 to be a special-purpose machine. According to one example, the techniques herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1010. Volatile media includes dynamic memory, such as main memory 1006. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1002. Transmission media can also take the form of acoustic or light waves, such as those generated during radio-wave and infra-red data communications.

The computer system 1000 also includes a communication/network interface 1018 coupled to bus 1002. Communication interface 1018 provides a two-way data communication coupling to one or more network links that are connected to one or more local networks. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN (or WAN component to communicated with a WAN). Wireless links may also be implemented. In any such implementation, communication interface 1018 sends and receives electrical, electromagnetic or optical signals that carry digital data streams representing various types of information.

The computer system 1000 can send messages and receive data, including program code, through the network(s), network link and communication interface 1018. In the Internet example, a server might transmit a requested code for an application program through the Internet, the ISP, the local network and the communication interface 1018. The received code may be executed by processor 1004 as it is received, and/or stored in storage device 1010, or other non-volatile storage for later execution.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
collecting log data from an application monitoring one or more hosts of a data center site;
based on the log data, creating a clique comprising a subset of the one or more hosts exhibiting sufficiently similar behavior relative to a threshold;
preparing the log data to train a machine learning model configured to predict existence of a predictive maintenance state for any of the subset of the one or more hosts of the clique;
training the machine learning model with the log data, and operationalizing the machine learning model to predict the existence of anomalous data in further log data collected from the application, the existence of anomalous data reflecting the existence of a predictive maintenance state.

2. The method of claim 1, further comprising fetching, from the one or more hosts, services information associated with each of the one or more hosts.

3. The method of claim 2, wherein the services information comprises a per-host list of logged services, the logged services comprising one or more measurands.

4. The method of claim 3, wherein creating the clique comprises iterating the log data over each of the one or more measurands.

5. The method of claim 4, wherein creating the clique further comprises determining a correlation between each of the pairs of the one or more hosts based on the per-measurand log data associated with each host of each of the pairs of the one or more hosts and the threshold, the correlation reflecting similarity of behavior.

6. The method of claim 5, wherein the preparing of the log data comprises, for each of the cliques removing non-valued vectors from the log data.

7. The method of claim 6, wherein the preparing of the log data further comprises, for each of the cliques, imputing the log data.

8. The method of claim 6, wherein the preparing of the log data further comprises, for each of the cliques, scaling the log data.

9. The method of claim 3, further comprising generating a time-host matrix, rows of which correspond to state values of each of the one or more measurands at various points in time.

10. The method of claim 9, further comprising removing from the time-host matrix, state values associated with a host that does not belong in the clique, creating a clique-specific time-host matrix.

11. The method of claim 10, further comprising imputing and scaling the clique-specific time-host matrix.

12. The method of claim 11, further comprising training the machine learning model with the state values of the imputed and scaled clique-specific time-host matrix.

13. The method of claim 1, wherein the machine learning model comprises an unsupervised autoencoder.

14. The method of claim 13, wherein the unsupervised autoencoder is designed for accurate reconstruction of non-anomalous log data from the monitoring application, and less-accurate reconstruction of anomalous log data from the monitoring application.

15. The method of claim 14, wherein the existence of anomalous data is determined based on a reconstruction error threshold.

16. A system, comprising:
a processor; and
a memory comprising machine-readable instructions that when executed, cause the processor to:
collect data reflecting state values corresponding to features of one or more hosts of a data center site;
process and derive representations of the collected data to create one or more groups comprising one or more subsets of the one or more hosts exhibiting sufficiently similar behavior relative to a threshold;
further process and derive representations of the collected data to train an unsupervised machine learning model configured to predict existence of a predictive maintenance state for any of the one or more subsets of the one or more hosts of the one or more groups;
predict the existence of anomalous data in further collected data, the existence of anomalous data reflecting the existence of a predictive maintenance state.

17. The system of claim 16, wherein the processing and deriving of the representations comprises generating a host matrix, each row of which represents the state values corresponding to the features of at least one host of the one or more hosts at a given time.

18. The system of claim 17, wherein the further processing and deriving of the representations comprises generating a time-host matrix, each row of which represents the state values corresponding to the at least one host of the one or more hosts at a given time.

19. The system of claim 16, wherein the unsupervised machine learning model is designed for accurate reconstruction of non-anomalous collected data, and less-accurate reconstruction of anomalous collected data.

20. The system of claim 19, wherein the existence of anomalous data is determined based on the reconstructed non-anomalous collected data and the reconstructed anomalous collected data relative to a reconstruction error threshold.
